(19) United States
(12) Patent Application Publication
(10) Pub. No.: US 2024/0008621 A1
(43) Pub. Date: Jan. 11, 2024

(54) CARRIER FOR A DISPENSABLE PRODUCT

(71) Applicant: DraxSlack, LLC, Prosper, TX (US)

(72) Inventor: Danny Glen Wilson, Prosper, TX (US)

(21) Appl. No.: 17/894,695

(22) Filed: Aug. 24, 2022

Related U.S. Application Data
(60) Provisional application No. 63/358,403, filed on Jul. 5, 2022.

(51) Int. Cl. A45D 40/18

(52) U.S. Cl. CPC A45D 40/18; A45D 2040/0025

(57) ABSTRACT

A carrier is provided for removably securing a portion of a container for a dispensable product therein. The carrier includes a receptacle defining a cavity including a first portion having a cavity wall structure structured to retentively engage a cap attachment portion of the product container when the cap attachment portion is positioned in the cavity first portion after removal of the cap from the cap attachment portion.

### CROSS-REFERENCE TO RELATED APPLICATIONS

This application claims the benefit of U.S. Provisional Patent Application No. 63/358,403, filed on Jul. 5, 2022, the disclosure of which is incorporated by reference herein in its entirety.

### TECHNICAL FIELD

The embodiments disclosed herein relate to a carrier structured for holding a dispensable product (such as lip balm or lipstick) between uses of the product and, more particularly, to a carrier structured to retentively engage any of multiple portions of a dispensable product container either singly or simultaneously.

### BACKGROUND

Many people frequently use lip balm to moisten dry lips. Athletes, in particular, may have problems with dry, cracked lips due to frequent exposure to sunlight during races and rapid breathing during intense physical activity. When an athlete is engaged in an activity such as running or biking, it may be distracting and physically difficult to remove a lip balm container from a pocket or storage pouch, remove the cap from the container, apply the lip balm, re-attach the cap, and re-pocket the container. Such activity requires the use of both hands and may entail physical movements that interfere with the athletic activity in which the user is engaged.

Thus, it would be beneficial to have a means for transporting a dispensable product container (such as a lip balm container) that may be securely positioned in a location that is convenient for accessing and returning the lip balm container with minimal extraneous movement, using a single hand of the user. It would also be beneficial to have a means for transporting a dispensable product container that holds the container securely when the container is undergoing shock and vibration, and that enables use of the dispensable product without the need to remove the cap before use.

### SUMMARY

In one aspect of the embodiments described herein, a carrier is structured for removably securing a portion of a container for a dispensable product therein. The carrier includes a receptacle defining a cavity including a first portion having a cavity wall structure structured to retentively engage a cap attachment portion of the product container when the cap attachment portion is positioned in the cavity first portion after removal of the cap from the cap attachment portion.

In another aspect of the embodiments described herein, a carrier is structured for removably securing a portion of a container for a dispensable product therein. The carrier includes a receptacle defining a cavity and a cap-retaining cavity portion structured to retentively engage a cap of the product container so that the cap is retained in the cavity when a body portion of the product container is separated from the cap.

### BRIEF DESCRIPTION OF THE DRAWINGS

A clear understanding of the key features of the embodiments disclosed herein may be had by reference to the appended drawings, which illustrate the method and system of the invention, although it will be understood that such drawings depict particular embodiments of the invention and, therefore, are not to be considered as limiting its scope with regard to other embodiments contemplated by the invention. In addition, similar elements or structures appearing in different drawing views showing different embodiments of the invention may be designated by similar reference characters.

FIG. 1 is a schematic perspective view of an exemplary dispensable product container suitable for retentive engagement by an embodiment of a carrier as described herein.

FIG. 2 is a schematic perspective view of a dispensable product carrier in accordance with an embodiment described herein.

FIG. 3 is a schematic plan view of portion of a bicycle, showing a possible application of the carrier embodiment shown in FIG. 1.

FIG. 4 is a schematic side cross-sectional view of the carrier embodiment shown in FIG. 2.

FIG. 4A is a magnified view of a portion of the carrier embodiment shown in FIG. 4.

FIG. 4B is a schematic rear end view of the carrier shown in FIGS. 4 and 4A.

FIG. 5 is a schematic side cross-sectional view of a dispensable product carrier in accordance with an alternative embodiment described herein.

FIG. 5A is a schematic rear view of the carrier shown in FIG. 5, showing a dispensable product container mounted in the carrier.

FIG. 6 is the schematic side cross-sectional view of the carrier shown in FIG. 4, showing a dispensable product container mounted in the carrier.

FIG. 6A is a magnified view of a portion of the carrier embodiment and product container shown in FIG. 6.

FIG. 7 is a schematic side cross-sectional view of a portion of a dispensable product carrier in accordance with another alternative embodiment described herein, also shown with a dispensable product container mounted in the carrier.

FIG. 8A is a schematic side cross-sectional view of a portion of a dispensable product carrier in accordance with yet another alternative embodiment described herein, also shown with a dispensable product container mounted in the carrier.

FIG. 8B is the side cross-sectional view of FIG. 8A, illustrating a method of extracting the product container from the carrier.

FIG. 9 is a schematic cross-sectional plan view of a double-ended alternative embodiment of the carrier.

FIG. 9A is a magnified view of a portion of the carrier embodiment shown in FIG. 9.

FIG. 10 is a schematic partial cross-sectional plan view of another double-ended alternative embodiment of the carrier.

FIG. 10A is a magnified view of a portion of the carrier embodiment shown in FIG. 10.

FIG. 11 is a schematic partial cross-sectional side view of an additional alternative embodiment of the carrier.

FIG. 12 is a partial cross-sectional side view of yet another alternative embodiment of the carrier.

### DETAILED DESCRIPTION

Described herein are embodiments of a carrier structured for holding a container for a dispensable product between uses of the product. The carrier may include a receptacle defining a cavity including a first portion having a cavity wall structure structured to retentively engage a cap attachment portion of the product container when the cap attachment portion is positioned in the cavity first portion after removal of the cap from the cap attachment portion. Embodiments of the cavity may also include a second portion having a cavity wall structure structured to retentively engage a body portion of the product container when the body portion of the product container is positioned in the cavity second portion. The ability to retain the product container in the carrier using any of the cap attachment portion and the body portion of the container increases the operational flexibility of the carrier. The ability to retain the product container in the carrier using both of the cap attachment portion and the body portion of the container simultaneously provides extra required extraction force in environments where severe shock and/or vibration are concerns.

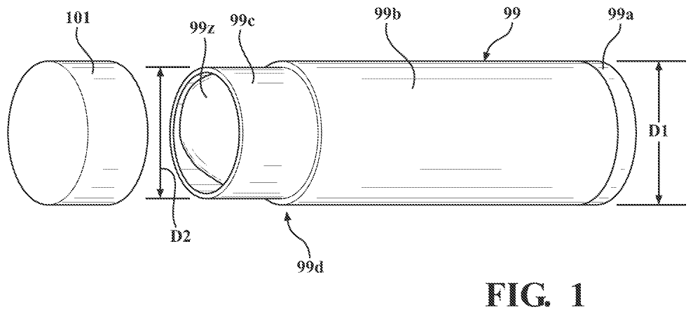

FIG. 1 is a schematic perspective view of an exemplary dispensable product container suitable for retentive engagement by an embodiment of a dispensable product container as described herein. Referring to FIG. 1, the dispensable product 99z may, for example, be lip balm or lipstick stored in a container 99 having a cylindrical body portion 99b typical for storing such products. The container 99 may be structured in a known manner so that a base portion 99a adjacent the body portion 99b of the container 99 is rotatable to dispense the product 99z or retract the product into the container body portion 99b. The container body portion 99b may have an outermost diameter D1. As is known in the art, the container 99 may have a product dispensing end 99d and a cap attachment portion 99c extending from the body portion 99b at the dispensing end 99d. The cap attachment portion 99c may have an outermost diameter D2 that is less than the body portion outermost diameter D1. The cap attachment portion 99c may be structured for insertion into a cap 101 usable for covering and protecting any exposed dispensable product 99z extending from the container body portion 99b and preventing contamination of the dispensable product 99z. In a known manner, the cap 101 and cap attachment portion 99c may be structured so as to form an interference fit therebetween when the cap attachment portion 99c is received in the cap 101, to affix the cap 101 to the cap attachment portion 99c. The cap 101 may have an outer diameter dimensioned so as to be the same as the outer diameter D1 of the container body portion 99b.

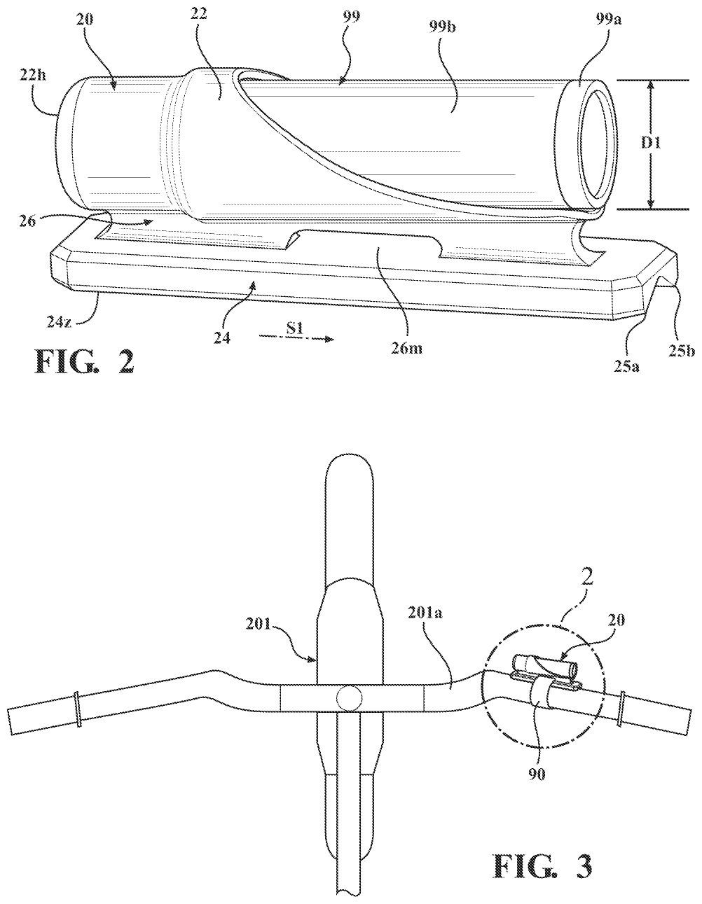

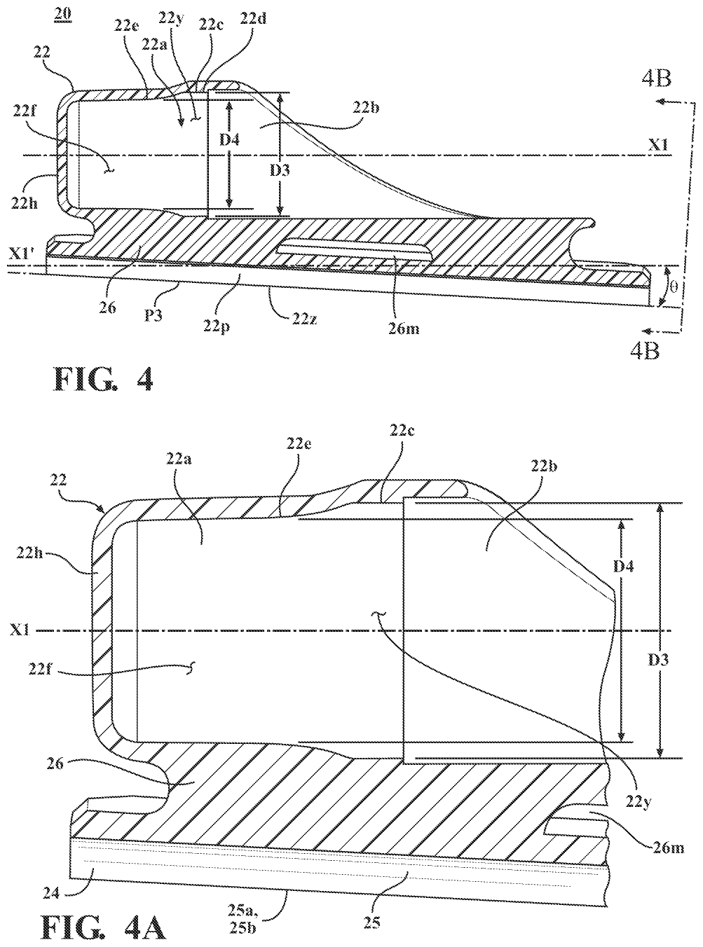

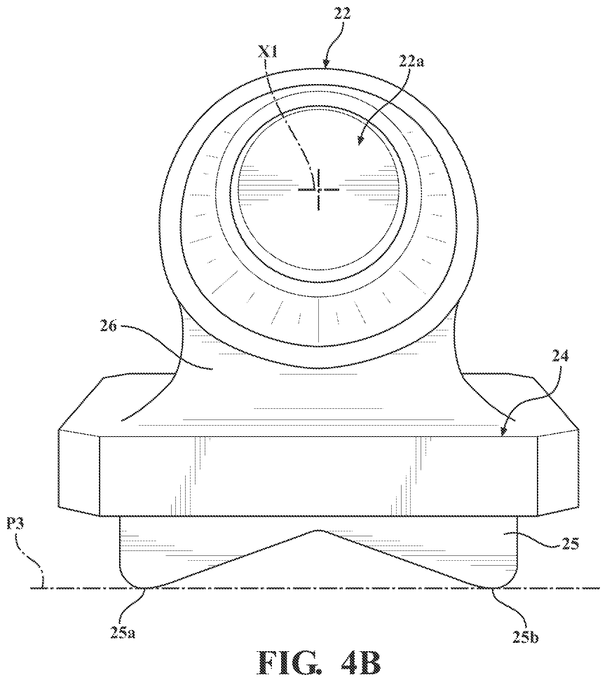

FIG. 2 is a schematic perspective exterior view of an embodiment of a carrier structured for removably securing therein a portion of a container 99 for a dispensable product. “Removably securing” means that a user is able to extract a portion of the container 99 from an associated portion of the carrier 20 by exerting at least a predetermined extraction force on the container 99, in a direction Si away from the carrier. FIG. 3 is a schematic plan view of portion of a bicycle 201, showing a possible application of the carrier 20 shown in FIG. 2. FIG. 4 is a schematic cross-sectional side view of the carrier embodiment shown in FIG. 2. FIG. 4A is a magnified view of a portion of the carrier embodiment shown in FIG. 4.

Referring to FIGS. 2, 4, and 4A, the carrier 20 may have a receptacle 22 defining a generally cylindrical cavity 22a having an opening 22b structured to receive therein a dispensing end 99d (FIG. 1) of the dispensable product container 99. The cavity 22a may have a central axis X1. In one or more arrangements, the cavity 22a may have a first portion 22e radially bounded and defined by an associated cavity wall structure 22f. The cavity wall structure 22f may be structured to retentively engage a cap attachment portion 99c (FIG. 1) of the product container 99 when the cap attachment portion 99c is positioned in the cavity first portion 22e after removal of the cap 101 from the cap attachment portion. In the embodiments described herein, retentive engagement between a cavity wall structure and a portion of a product container may occur when direct physical contact between the cavity wall structure and the portion of the product container produces contact forces sufficient to ensure that at least a predetermined extraction force will be required to extract the portion of the product container from the portion of the cavity that includes the wall structure.

For example, in one or more arrangements, in embodiments where the carrier retentively engages the product container along the container cap attachment portion, the cavity wall structure engaging the cap attachment portion may be structured with respect to an outermost dimension (such as outer diameter D2) of the cap attachment portion 99c so that the minimum extraction force required to separate the cap attachment portion from the cavity wall structure is at least equal to an extraction force required to separate the container body from the container cap in a product container of the type being engaged by the carrier.

Similarly, in one or more arrangements, in embodiments where the carrier retentively engages the product container along the container body portion 99b, the cavity wall structure engaging the body portion may be structured with respect to an outermost dimension (such as outer diameter D1) of the body portion 99b so that the minimum extraction force required to separate the body portion from the cavity wall structure is at least equal to an extraction force required to separate the container body portion from an associated container cap of the product container, in a product container of the type being engaged by the carrier.

In one or more arrangements, in embodiments where the product container retentively engages the product container along the cap and the cap is to be retained in the carrier when the container body portion is separated from the cap, the cavity wall structure engaging the cap may be structured with respect to an outermost dimension of the cap so that the minimum extraction force required to separate the cap from the cavity wall structure is greater than the extraction force required to separate the container body from the cap in a product container of the type being engaged by the carrier. This criterion ensures that the cap will be retained in the carrier when the container body portion is separated from the cap.

Optimum value(s) of the pertinent extraction forces, carrier dimension(s) and/or other parameters may be determined by calculation and/or iteratively, by experimentation for various designs of product containers. The carrier tooling and/or manufacturing processes may then be adjusted to provide the desired extraction forces.

The first, second, third and fourth cavity portions described herein may include both the space in which a respective portion of the product container is received, and the receptacle structure (e.g., wall structures including cavity walls, projections, etc.) enclosing and defining the space in which the portion of the container is received. A wall structure of a portion of a cavity may include a wall of the receptacle enclosing the cavity, any projections extending from the wall, and any other structures defining a radial boundary of the portion of the cavity.

The extraction force provided by retentive engagement between any portion of the product container and an associated cavity wall structure may depend on the surface area over which the product container and the cavity wall structure are in direct physical contact, the coefficient of static friction between the surfaces of the portion(s) of the product container and the cavity wall structure in direct physical contact, the cavity wall structure dimensions pertinent to any interference fits between the wall structure and the pertinent portion of the product container, and other pertinent factors. An extraction force within a predetermined range or having a predetermined minimum value may be provided by adjusting one or more of the above-mentioned parameters. Optimum value(s) of the pertinent carrier dimension(s), extraction forces and other parameters may be determined by calculation and/or iteratively, by experimentation.

In one or more arrangements, retentive engagement between a cavity wall structure and an associated portion of the product container may be provided by specifying one or more dimensions of the cavity wall structure with respect to associated dimension(s) of the product container so that one or more interference fits are created between the portion of the product container and the cavity wall structure when the portion of the product container is positioned inside the portion of the cavity containing the wall structure. The interference fit(s) may be generated, for example, when an outer diameter or other dimension of a portion of the product container slightly exceeds an associated dimension of the cavity wall structure.

For example, referring to FIGS. 4 and 4A, the first portion cavity wall structure 22f may be cylindrical and have an inner diameter D4 structured so that the outermost diameter D2 of the cap attachment portion 99c slightly exceeds the inner diameter D4 of the first portion cavity wall structure, thereby producing an interference fit between the first portion cavity wall structure 22f and the cap attachment portion 99c when the cap attachment portion is inserted into the cavity first portion 22e.

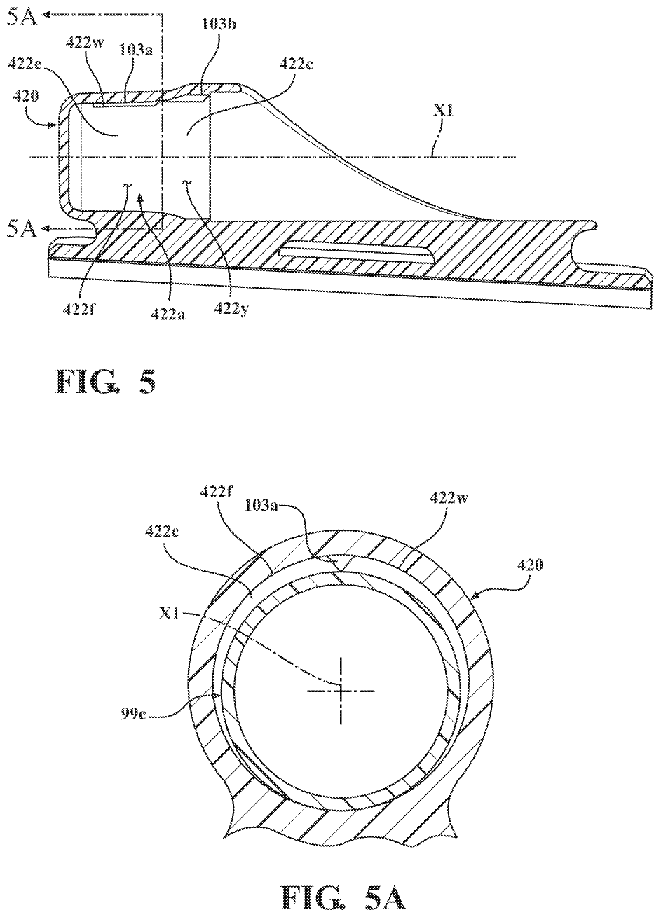

In one or more other arrangements, a cavity wall structure may include at least one projection extending from a wall of the wall structure in a direction toward the cavity. The at least one projection may be structured to directly physically contact an associated portion of the product container to form the interference fit when the portion of the product container is inserted into the portion of the cavity containing the at least one projection. For example, FIG. 5 is a schematic side cross-sectional view of a particular embodiment 420 of the carrier, showing projections 103 structured for engaging portions of the product container 99. FIG. 5A is a schematic end view of a cavity first portion 422e of the carrier 420 of FIG. 5, and showing a portion of a product container 99 inserted into the cavity first portion 422e. Referring to FIGS. 5 and 5A, in one or more other arrangements, the wall structure 422f of cavity first portion 422e may include at least one projection 103a extending from a wall 422w of the cavity wall structure 422f in a direction toward the cavity 422a. The at least one projection 103a may be structured to directly physically contact the cap attachment portion 99c to form the interference fit with the cap attachment portion 99c when the cap attachment portion is inserted into the cavity first portion 422e. In one or more arrangements, the projection(s) 103 may be in the form of suitable crush rib(s) structured to radially crush or deform in a known manner to a degree depending on a mismatch between a dimension of the cavity first portion 422e partially defined by the rib(s) 103a, and the outermost diameter D2 of the cap attachment portion 99b. Also contemplated are other arrangements of ribs as well as other methods of forming interference fits between portions of the product container and the cavity wall structures.

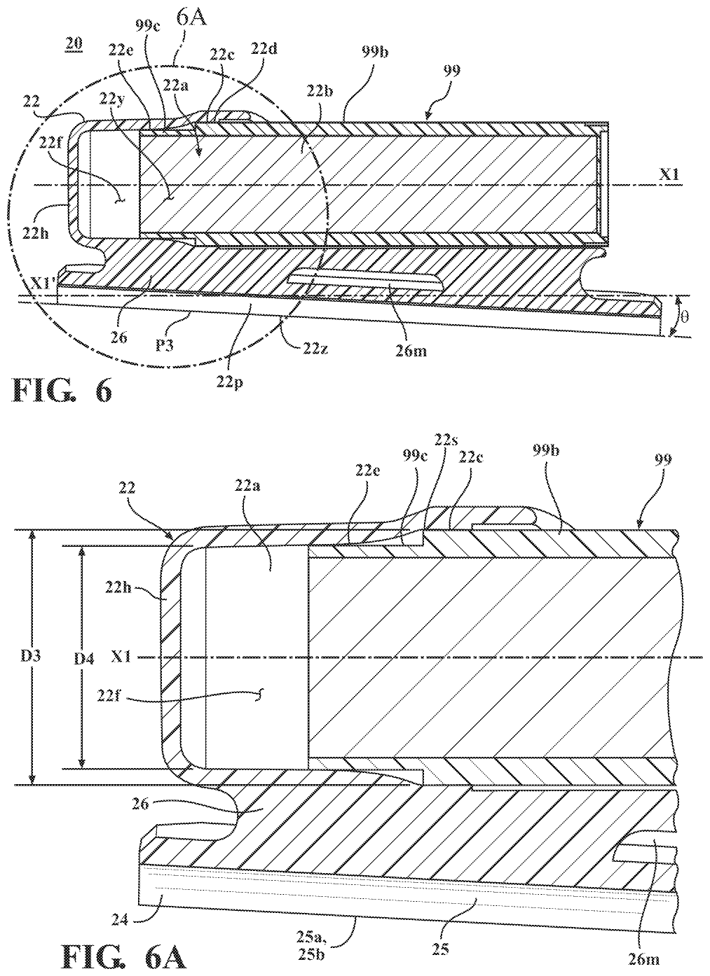

Referring to again FIGS. 2, 4, and 4A, in particular arrangements, as well as having a first portion 22e structured to retentively engage a cap attachment portion 99c of the product container 99 when the cap attachment portion is positioned in the cavity first portion 22e, the cavity 22a may further include a second portion 22c adjacent the cavity first portion 22e. The cavity second portion may be radially bounded and defined by an associated cavity wall structure 22y. The cavity wall structure 22y may be structured to retentively engage a body portion 99b of the product container 99 when the body portion is positioned in the cavity second portion 22c. Thus, in certain embodiments, the receptacle 22 may engage the container 99 in two separate interference fits, along both the cavity first portion 22e and the cavity second portion 22c. Such a situation is shown in FIGS. 6 and 6A. FIG. 6 is a schematic cross-sectional side view of the carrier 20 of FIG. 4 showing a product container 99 positioned in the cavity 22a, with a cap attachment portion 99c of the container 99 retentively engaged by the cavity first portion 22e of the carrier 20 and a body portion 99b of the container 99 retentively engaged by the cavity second portion 22c. FIG. 6A is a magnified view of a portion of the view shown in FIG. 6.

Referring to FIG. 6A, the receptacle 22 may be structured so that, in embodiments of the carrier formed from a relatively rigid material, a region where an interior diameter of the cavity wall begins to decrease from the cavity second portion interior diameter D3 to the cavity first portion interior diameter D4 effectively forms a shoulder or hard stop 22s which may limit further insertion of the product container 99 into the receptacle cavity 22a.

In the manner previously described with respect to the cavity first portion 22e, to retentively engage the container body portion 99b, the wall structure 22y of the cavity second portion 22c may be cylindrical and have an interior diameter D3 structured so that an outermost diameter D1 of container body portion 99b slightly exceeds the inner diameter D3 of the second portion cavity wall structure 22y, thereby producing an interference fit between the second portion cavity wall structure 22y and the container body portion 99b when the body portion is inserted into the cavity second portion 22c. Alternatively, in the manner previously described with respect to the cavity first portion 22e, the cavity wall structure 22y of the cavity second portion 22c may include at least one projection 103b (FIG. 5) extending from a cavity wall of the cavity wall structure 22y in a direction toward the cavity 22a and structured to directly physically contact the container body portion 99b to form the interference fit with the body portion 99b when the body portion is inserted into the cavity second portion 22c.

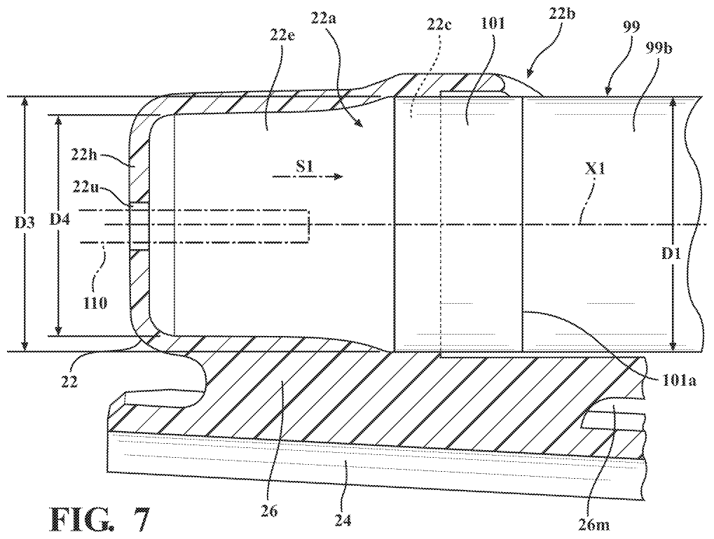

Referring now to FIG. 7, in one or more arrangements, as well as the wall structure 22y of the cavity second portion 22c being structured to retentively engage a body portion 99b of a product container 99 when the body portion is positioned in the cavity second portion 22c, the cavity wall structure 22y of the cavity second portion 22c may be structured to retentively engage a cap 101 of the product container 99 when the cap 101 is positioned in the cavity second portion 22c, such that the cap 101 is retained in the cavity second portion 22c when a user separates the container body portion 99b from the cap 101. To this end, the second portion cavity wall structure 22y may be structured with respect to the cap 101 so as to provide an interference fit that prevents removal of the cap 101 from the cavity second portion 22c during normal usage of the dispensable product. This arrangement may enable a user to insert the capped product container 99 into the cavity second portion 22c, thereby generating an interference fit between the cap 101 and the carrier. Since an extraction force produced by the cap interference fit (i.e., the force required to remove the cap 101 from the cavity second portion 22c) is greater than the extraction force required to separate the container body portion 99b from the cap 101, the user may separate the body portion 99b from the cap 101 in the normal manner of using the product, while the cap 101 is retained within the cavity second portion 22c.

Referring to FIG. 7, in particular arrangements, the cavity second portion 22c may be dimensioned with respect to the dimensions of cap 101 so that a manually grippable portion 101a of the cap 101 extends out of the cavity second portion 22c when the cap 101 is retentively engaged by the second portion cavity wall structure 22y. In such arrangements, when the user is finished using the carrier, the user may extract the cap 101 from the cavity second portion 22c by gripping the cap 101 and applying sufficient extraction force to the cap.

Referring again to FIG. 7, in one or more arrangements, the receptacle 22 may also have an end portion 22h defining a boundary of the cavity 22a. In one or more arrangements, the receptacle end portion 22h may be located so as to enable a quantity of dispensable product to extend from an open end of the container 99 into a portion of the cavity 22a adjacent the end portion 22h without contacting the receptacle 22, so that the product is immediately ready for use after being withdrawn from the receptacle. In particular arrangements, the end portion 22h has an opening 22u extending therethrough and structured to enable an object 110 to be inserted through the opening 22u and into the cavity 22a to contact the cap 101 of the product container 99 when the cap is secured in the cavity second portion 22c. The object 110 may be used to push the cap 101 in direction S1 toward the cavity opening 22b, thereby enabling a user to retrieve the cap 101.

Referring to FIGS. 2 and 4-4B, the carrier 20 may also have a base portion 24. FIG. 4B is a schematic end view of the base portion 24 of the carrier embodiment shown in FIGS. 2 and 4-4A. The base portion 24 may be structured to enable securement of the carrier to an object, such as a user's wrist or the handlebars 201a of a bicycle 201 as shown in FIG. 2.

Referring to FIGS. 4-4B, in one or more arrangements, the base portion 24 may include a bearing portion 25 which forms an inverted “V”-shape. Opposed parallel edges 25b of the bearing portion 25 may provide associated bearing surfaces against which the base portion 24 may rest, to enable the base portion 24 to be secured to an object such as a bicycle handlebar or a limb of a user. The arrangement shown may provide a high-stability structure for mounting and use of the carrier 20 when the base portion 24 is rested and secured against any of a cylindrical object surface (as provided by the bicycle handlebar 201a shown in FIG. 3) and a flat object surface.

The carrier 20 may also include a support portion 26 extending from the base portion 24 to the receptacle 22, thereby enabling the base portion 24 to support the receptacle 22 when the base portion is secured to an object. In one or more arrangements, the support portion 26 may combine with the base portion 24 to define one or more openings 26m structured to enable strap(s) or other securement means to be fed therethrough. Any of a variety of devices and methods may be used to secure the carrier to an object such as a bicycle handlebar, a motor vehicle steering wheel, a limb of a user, etc. Exemplary carrier securement mechanisms may include strap(s), adhesives, Velcro® strips, and any other suitable devices.

Referring to FIGS. 4 and 4B, in particular arrangements, the support portion 26 may be structured so as to support the receptacle 22 so that the receptacle cavity central axis X1 extends at a non-zero angle θ with respect to a flat plane P3 including base portion bearing surfaces 25a, 25b (FIG. 4B) when the product container 99 is removably secured in the carrier 20. FIG. 4 shows the plane P3 extending at a non-zero angle θ with respect to a plane X1′ extending parallel to the axis X1. Angling the cavity central axis X1 with respect to the plane P3 may bias the cavity opening 22b in a direction away from an object to which the carrier 20 is mounted, thereby facilitating more convenient user access to the dispensable product.

In particular embodiments, at a least a portion of the receptacle 22 may be formed from a clear material (such as a transparent polymer material or other suitable material) so that a user can see how much (if any) dispensable product extends from the product container 99 before the container 99 is withdrawn from the receptacle 22. This may enable a user to use a single hand to rotate the container base portion 99a and adjust the amount of exposed product if desired, prior to withdrawal of the container 99 from the carrier. A clear material may be a material that allows light to pass through so that objects within at least the end portion of the cavity can be distinctly seen.

In one or more arrangements, carrier embodiments described herein may be formed from a relatively rigid polymer or other material suitable for achieving and maintaining interference fits sufficient to retain or secure a portion of the dispensable product container 99 within an associated portion a receptacle cavity as described herein.

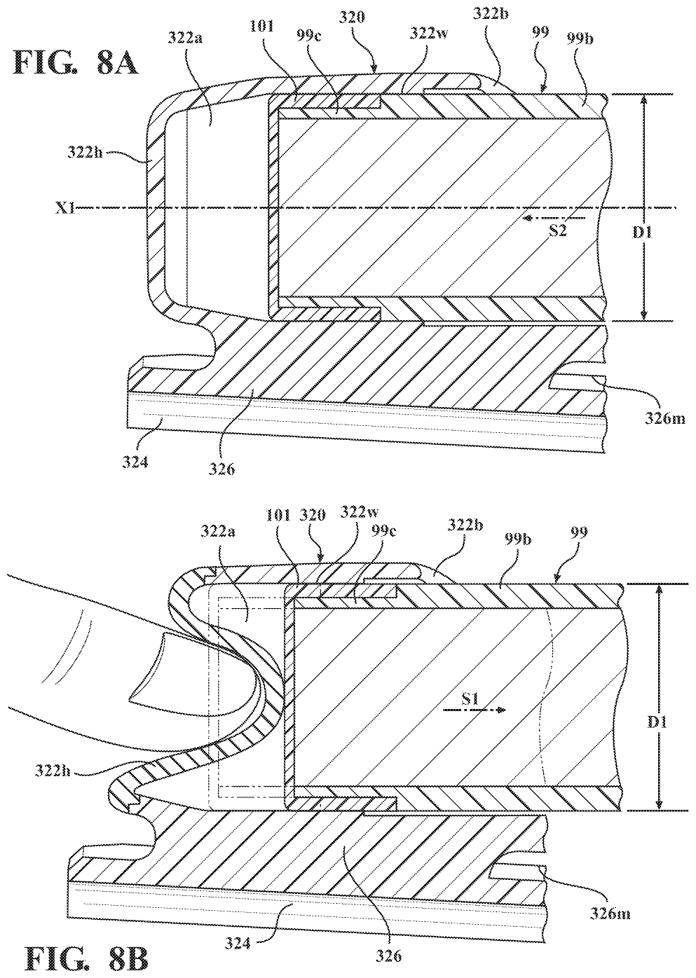

FIG. 8A is a schematic side cross-sectional view illustrating an alternative embodiment 320 of the carrier. FIG. 8B is the side cross-sectional view of FIG. 8A showing one method of extracting the dispensable product container from the carrier. The carrier embodiment 320 shown in FIGS. 8A and 8B may be formed from a resiliently deformable material, such as a rubber or vinyl composition. Otherwise, the carrier 320 may have a structure in accordance with any other single-ended carrier embodiment described here in.

When using a resiliently deformable material instead of a relatively rigid material, particular dimensions of the receptacle cavity wall structures may be adjusted as needed to provide interference fits suitable for retaining the dispensable product container in the receptacle cavity and providing an extraction force having at least a minimum value. The resiliently deformable material may be selected so as to enable a user to move a portion of a product container 99 (including a cap applied to the product container) into the cavity first portion as shown in FIG. 8A, by exerting a force on the product container in a direction S2 toward the cavity first portion 322e. Thus, referring to FIG. 8A, if a user desires to leave the cap 101 on the dispensable product container 99, the user may press the capped dispensable product container 99 through the opening 322b and into the cavity 322a. The relatively softer material of the receptacle 322 may permit the cavity interior walls (generally designated 322w) to expand to accommodate the outer diameter D1 of the cap 101 and form an interference fit with the cap.

Referring to FIG. 8B, due to the interference fit between the cap 101 and the cavity interior walls 322w, it may be difficult or impossible to extract the cap 101 from the cavity 322a by simply extracting the container body portion 99b. In one or more arrangements, the resiliently deformable material may be structured to enable a user to exert a force on the cap by manually resiliently deforming the receptacle end portion 322h into contact with the cap 101. Thus, as shown in FIG. 8B, the relatively softer material of the receptacle 322 may be specified so as to enable the user to press a finger into the receptacle end portion 322h in a direction Si toward the cavity opening 322b to urge the cap 101 (or both the cap 101 and container 99) out of the opening 322b.

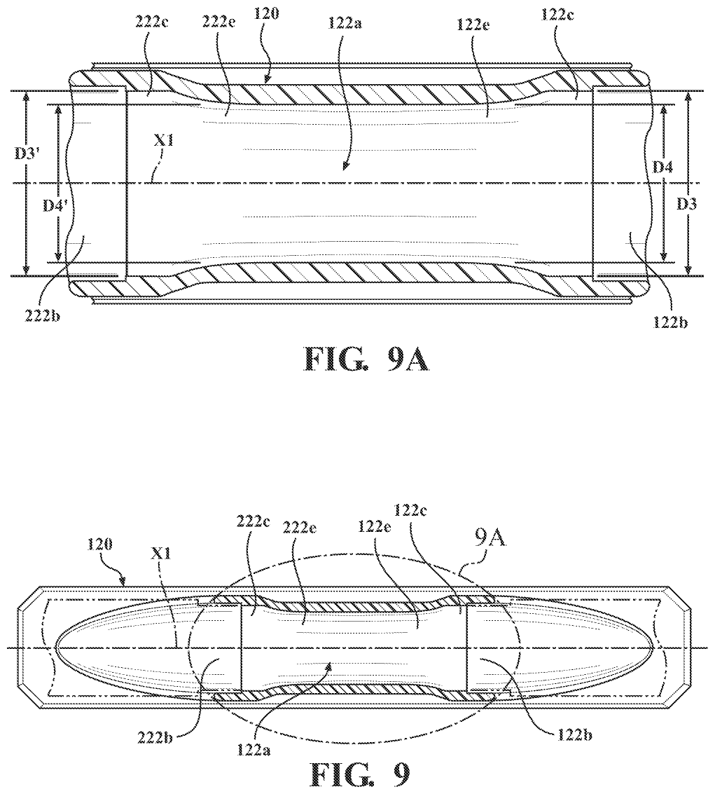

Referring now to FIGS. 9 and 9A, FIG. 9 is a schematic cross-sectional plan view of a double-ended alternative embodiment 120 of the carrier. FIG. 9A is a magnified view of a portion of the carrier embodiment 120 shown in FIG. 9. In this embodiment, the same receptacle structure as shown in FIGS. 2 and 4-4B may be “mirror-imaged” to form a structure in which the cavity 122a has two opposed openings 122b, 222b instead of a single opening. The cavity 122a may have various portions 122e, 122c, 222e, 222c structured in the same manner as the first and second portions 22e, 22c of cavity 22a in FIGS. 2 and 4-4B. The cavity portions 122e, 122c, 222e, 222c may be structured to receive and secure therein associated portions of the same product container or different product containers having the same size (i.e., any product container(s) having the outermost diameters D1 and D2 previously described). For example, cavity 122a may have a first portion 122e with the same inner diameter (D4) as cavity first portion 22e and may otherwise be structured the same as cavity first portion 22e, with a wall structure configured to retentively engage a cap attachment portion 99c of a product container 99 when the cap attachment portion is positioned in the cavity first portion 122e after removal of the cap. Cavity 122a may also include a second portion 122c adjacent the first portion 122e. The cavity second portion 122c may have the same inner diameter (D3) as cavity second portion 22c and may be otherwise structured the same as cavity second portion 22c, with a wall structure configured to retentively engage the product container body portion 99b (and, optionally, the container cap 101) when the body portion 99b is positioned in the cavity second portion 122c.

In addition, cavity 122a of structure 120 may include a third portion 222e adjacent the first portion 122e. The cavity third portion 222e may have an inner diameter D4′ the same as diameter D4 and may otherwise be structured the same as cavity first portions 22e and 122e, with a wall structure configured to retentively engage the cap attachment portion of the product container when the cap attachment portion is positioned in the cavity third portion 222e after removal of the cap. Cavity 122a may also include a fourth portion 222c adjacent the third portion 222e. The fourth portion 222c may have an inner diameter D3′ the same as diameter D3 and may otherwise be structured the same as cavity second portions 22c and 122c, with a wall structure configured to retentively engage the product container body portion 99b (and, optionally, the container cap 101) when the body portion 99b is positioned in the cavity fourth portion 222c.

The structure just described may enable dispensable product container(s) 99 of a single, given size to be inserted into the cavity 122a through either (or both) of openings 122b, 222b, depending on the preference of a user. This enables a user to select which side of the carrier to use to secure the product container, and may also enable a user to store two product containers simultaneously.

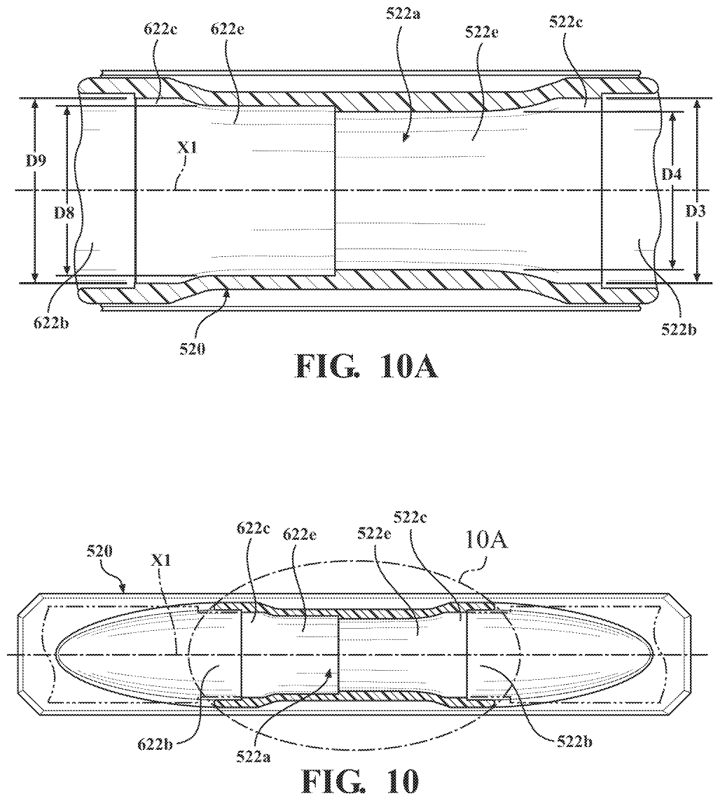

Referring now to FIGS. 10 and 10A, FIG. 10 is a schematic partial cross-sectional plan view of a double-ended alternative embodiment 520 of the carrier. FIG. 10A is a magnified view of a portion of the carrier embodiment 520 shown in FIG. 10. In this embodiment, one end or side of the carrier may have the same receptacle structure and dimensions as shown in FIGS. 2 and 4-4B. Ends of the carrier 520 may have respective first and second openings 522b and 622b.

The cavity 522a may have first and second portions 522e, 522c structured in the same manner as the first and second portions 22e, 22c of cavity 22a in FIGS. 2 and 4-4B, with opening 522b leading into the cavity first and second portions 522e, 522c. The cavity portions 522e and 522c may be structured to receive and secure therein associated portions of a product container having a first given size (for example, any product container having the outermost diameters D1 and D2 previously described). For example, cavity 522a may have a first portion 522e with the same inner diameter (D4) as cavity first portion 22e and may otherwise be structured the same as cavity first portion 22e, with a wall structure configured to retentively engage a cap attachment portion of a first product container when the cap attachment portion is positioned in the cavity first portion 122e after removal of the cap. Cavity 522a may also include a second portion 522c adjacent the first portion 522e. The cavity second portion 522c may have the same inner diameter (D3) as cavity second portion 22c and may be otherwise structured the same as cavity second portion 22c, with a wall structure configured to retentively engage the body portion 99b (and, optionally, the container cap 101) of the first product container 99 when the body portion 99b is positioned in the cavity second portion 522c.

In addition, cavity 522a of carrier 520 may include a third portion 622e adjacent the first portion 522e. The cavity third portion 622e may have an inner diameter D8 different from the diameter D4 and may otherwise be structured to retentively engage a cap attachment portion of another or second, different-sized product container (not shown) when the cap attachment portion is positioned in the cavity third portion 222e after removal of the cap. The different-sized product container may, for example, have outermost diameters of the cap attachment portion and cap/container body portion different from the outermost diameters of the cap attachment portion and cap/container body portion of the product container retentively engaged in first and second cavity portions 522e and 522c. In addition, the cavity 522a may include a fourth portion 622c adjacent the third portion 622e. The cavity fourth portion 622c may have an inner diameter D9 different from the diameter D3 and may otherwise be structured to retentively engage the body portion of the other product container when the body portion of the other product container is positioned in the cavity fourth portion 622c. Opening 622b may lead into the cavity third and fourth portions 622e, 622c. The structure just described may enable the carrier 520 to retentively engage either (or both of) product containers having at least two different sizes.

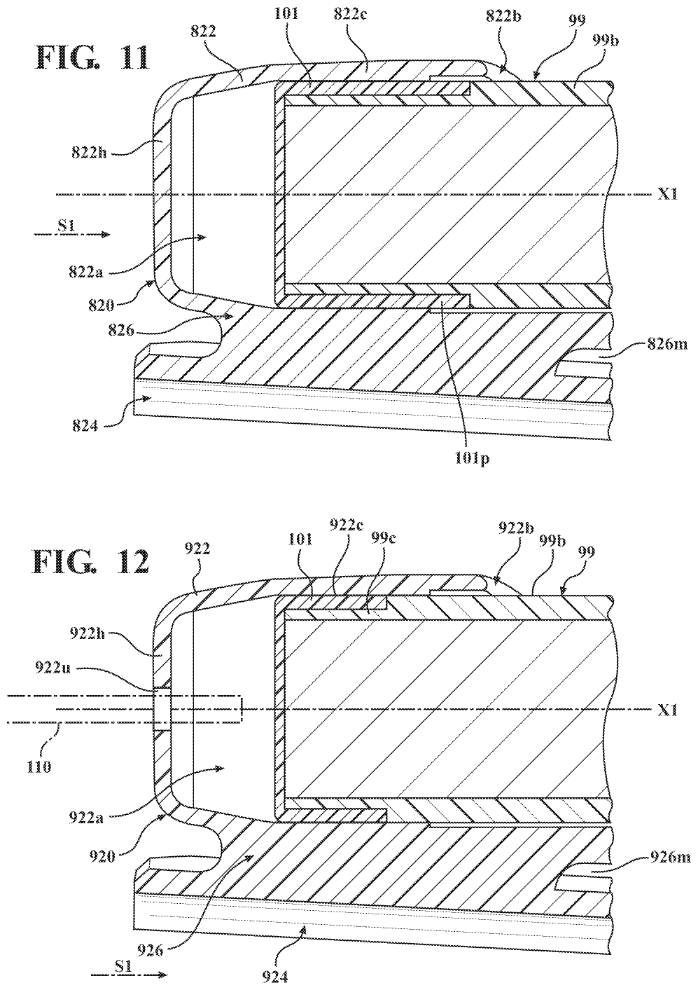

FIG. 11 is a partial cross-sectional side view (similar to the views of FIGS. 6A and 7) of an additional embodiment 820 of the carrier. Referring to FIG. 11, in one or more arrangements, the carrier 820 may include a receptacle 822 defining a cavity 822a and a cap-retaining cavity portion 822c structured to retentively engage a cap 101 of a dispensable product container 99 when the cap 101 is positioned in the cavity portion 822c, so that the cap 101 is retained in the cavity portion 822c when a body portion 99b of the product container 99 is separated from the cap 101. Thus, the cap 101 may be retained in the carrier 820 during normal use of the product by a user, and the user can conveniently re-connect the body portion 99b to the cap 101 after use. The cap-retaining cavity portion 822c may retentively engage the cap 101 by generation of one or more interference fits as previously described herein, using any of a variety of methods and structures. The receptacle 822 may also include an end portion 822h defining a boundary of the cavity 822a. The carrier 820 may further include an associated base portion 824 and a support portion 826 connecting the base portion 824 and the receptacle 822 structured as previously described with regard to other embodiments of the carrier.

Referring to FIG. 11, in some arrangements, the cap-retaining cavity portion 822c of the carrier 820 may be structured to retentively engage a portion of the cap 101 spaced apart from the body portion 99b of the product container 99. Thus, in such arrangements, the cap-retaining cavity portion 822c will only contact the cap 101 and not the body portion 99b of the container 99. This may retain the cap 101 in the carrier 820 during separation of the body portion 99b from the cap 101, and may also result in positioning of the cap 101 relatively closer to a cavity opening 822b into which the capped end of the product container 99 is inserted. Thus, in this arrangement, an end portion 101p of the cap 101 may extend past the cap-retaining cavity portion 822c, where it may be relatively more accessible to a user attempting to manually extract the cap 101 from the carrier 820.

FIG. 12 is a partial cross-sectional side view similar to the view of FIG. 11 of yet another embodiment 920 of the carrier. The embodiment shown in FIG. 12 may be structured similarly to the embodiment shown in FIG. 11, except that a cap-retaining cavity portion 922c of the carrier 920 may also be structured to contact the body portion 99b of the product container 99 when the cap 101 is retentively engaged by the cap-retaining cavity portion 922c. In such arrangement(s), the cap-retaining cavity portion 922c may not be structured to retentively engage the container body portion 99b; rather, the cap-retaining cavity portion 922c may exert some contact force on the body portion 99b along an area of the body portion adjacent the cap 101, but the contact force may be insufficient to interfere with separation of the body portion 99b from the cap 101. This arrangement may provide some degree of additional required extraction force for maintaining the product container 99 in the carrier. The carrier 920 may further include an associated base portion 924 and a support portion 926 connecting the base portion 924 and the receptacle 922 as previously described with regard to other embodiments of the carrier.

Referring again to FIG. 12, the carrier embodiment shown may also include an end portion 922h defining a portion of the cavity 922a. The end portion 922h may have an opening 922u extending therethrough and structured to enable an object 110 to be inserted through the opening 922u and into the cavity 922a to contact the cap 101 of the product container 99 (in a manner similar to that described with regard to FIG. 7). This may facilitate extraction of the cap 101 from the carrier 920 by a user when the cap 101 is positioned deep within the cavity 922a.

The carrier embodiments shown in FIGS. 11-12 may be formed from a relatively rigid material.

The carrier embodiments described herein may be attachable to any of a variety of objects, depending on the requirements of a user. Exemplary (but non-exclusive) carrier attachment locations include vehicle handlebars, steering wheels, dashboards, and other parts of a vehicle (e.g., conventional motor vehicle, bicycle, motorcycle, snowmobile, jet ski, canoe, kayak, all-terrain vehicle, etc.), horse saddles, portions of a user's body (waist, bicep, wrist, thigh, ankle, etc.), golf bags, motorized golf carts, athletic bags, briefcases, backpacks, purses, bicycle frames, ski poles and other locations.

The carrier may be attached to an object using any mechanism structured to maintain attachment of the carrier to the given object during extraction and re-insertion of the dispensable product container. Exemplary (but non-exclusive) carrier attachment methods include straps (e.g., dedicated straps, existing straps found on backpacks, purses, and other such items used to carry objects), Velcro® strips, belts worn with pants or other clothing items, adhesive materials (e.g., double-sided tape, glue), mechanical fasteners (such as screws), mounting brackets, adapters, or clips designed to hold and/or be mateable with the carrier, to secure the carrier in a given end-use environment, and other methods and mechanisms. In one or more arrangements, the carrier and attachment method(s) may be selected to enable the carrier to be moved from one object and attached to another object as the user changes activities, modes of transportation, locations, etc.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A carrier structured for removably securing a portion of a container for a dispensable product therein, the carrier comprising a receptacle defining a cavity including a first portion having a cavity wall structure structured to retentively engage a cap attachment portion of the product container when the cap attachment portion is positioned in the cavity first portion after removal of the cap from the cap attachment portion.

2. The carrier of claim 1 wherein the cavity further includes a second portion having a cavity wall structure structured to retentively engage a body portion of the product container when the body portion of the product container is positioned in the cavity second portion.

3. The carrier of claim 2 wherein the second portion cavity wall structure is structured to retentively engage a cap of the product container when the cap is positioned in the cavity second portion so that the cap is retained in the cavity second portion when a user separates the body portion of the product container from the cap.

4. The carrier of claim 3 wherein the receptacle further comprises an end portion defining a boundary of the cavity, the end portion having an opening extending therethrough and structured to enable an object to be inserted through the opening and into the cavity to contact the cap of the product container when the cap is positioned in the cavity.

5. The carrier of claim 1, wherein the receptacle includes an end portion positioned adjacent the cavity first portion, the cavity first portion and the end portion combining to define a space structured to receive therein a quantity of dispensable product extending from an end of the product container.

6. The carrier of claim 1, further comprising a base portion and a support portion extending from the base portion to the receptacle and structured to support the receptacle so that the product container extends at a non-zero angle with respect to a plane defined by a bearing surface of the base portion when the portion of the product container is removably secured in the carrier.

7. The carrier of claim 1, wherein at least a portion of the receptacle is formed from a clear material.

8. The carrier of claim 1, wherein the receptacle is formed from a resiliently deformable material structured to enable a user to move a portion of a product container, including a cap applied to the product container, into the cavity first portion by exerting a force on the product container in a direction toward the cavity first portion.

9. The carrier of claim 8, wherein the receptacle includes an end portion positioned adjacent the cavity first portion, and wherein the resiliently deformable material is structured to enable a user to exert a force on the cap by manually resiliently deforming the end portion into contact with the cap.

10. The carrier of claim 1, wherein the cavity includes a third portion positioned adjacent the cavity first portion and having a cavity wall structure structured to retentively engage the cap attachment portion of the product container when the cap attachment portion is positioned in the cavity third portion after removal of the cap from the cap attachment portion.

11. The carrier of claim 10, wherein the cavity includes a fourth portion positioned adjacent the cavity third portion and having a cavity wall structure structured to retentively engage the product container body portion when the product container body portion is positioned in the cavity fourth portion.

12. The carrier of claim 11, wherein the fourth portion cavity wall structure is structured to retentively engage a cap of the product container when the cap is positioned in the cavity fourth portion so that the cap is retained in the receptacle cavity when a user separates the body portion of the product container from the cap.

13. The carrier of claim 1, wherein the cavity includes a third portion adjacent the cavity first portion and having a cavity wall structure structured to retentively engage a cap attachment portion of another, different-sized product container when the cap attachment portion of the other product container is positioned in the cavity first portion after removal of the cap, the cap attachment portion of the different-sized product container having an outermost diameter different from an outermost diameter of the cap attachment portion of the product container.

14. The carrier of claim 13, wherein the cavity includes a fourth portion positioned adjacent the cavity third portion and having a cavity wall structure structured to retentively engage a body portion of the different-sized product container when the body portion of the different-sized product container is positioned in the cavity fourth portion. The carrier of claim 14, wherein the body portion of the different-sized product container has an outermost diameter different from an outermost diameter of the body portion of the product container.

16. The carrier of claim 14, wherein the fourth portion cavity wall structure is structured to retentively engage a cap of the other product container when the cap is positioned in the cavity fourth portion so that the cap is retained in the receptacle cavity when a user separates the body portion of the other product container from the cap.

17. A carrier structured for removably securing a portion of a container for a dispensable product therein, the carrier comprising a receptacle defining a cavity and a cap-retaining cavity portion structured to retentively engage a cap of the product container so that the cap is retained in the cavity when a body portion of the product container is separated from the cap.

18. The carrier of claim 17, wherein the cap-retaining cavity portion is structured to retentively engage a portion of the cap spaced apart from a body portion of the product container.

19. The carrier of claim 17, wherein the receptacle further comprises an end portion of the cavity defining a portion of the cavity, the end portion having an opening extending therethrough and structured to enable an object to be inserted through the opening and into the cavity to contact the cap of the product container when the cap is positioned in the cavity.
